(19) United States
(12) Patent Application Publication
(10) Pub. No.: US 2026/0041090 A1
(43) Pub. Date: Feb. 12, 2026

(54) ANTIBACTERIAL AND ANTIVIRAL COATING FILM CONTAINING SUPRAMOLECULAR SOL COMPRISING POLYPHENOL-BASED COMPOUND AND TRIVALENT IRON SALT

(71) Applicants: HANSOL ROOTONE AGRICULTURAL CORPORATION CO., LTD., Dangjin-si Chungcheongnam-do (KR); KOREA ADVANCED INSTITUTE OF SCIENCE AND TECHNOLOGY, Daejeon (KR)

(72) Inventors: Hansol HWANG, Dangjin-si Chungcheongnam-do (KR); Insung CHOI, Daejeon (KR); Sangyeong HAN, Daejeon (KR); Gyeongwon YUN, Daejeon (KR)

(73) Assignees: HANSOL ROOTONE AGRICULTURAL CORPORATION CO., LTD, Dangjin-si Chungcheongnam-do (KR); KOREA ADVANCED INSTITUTE OF SCIENCE AND TECHNOLOGY, Daejeon (KR)

(21) Appl. No.: 19/360,261

(22) Filed: Oct. 16, 2025

Related U.S. Application Data
(63) Continuation of application No. PCT/KR2023/018059, filed on Nov. 10, 2023.

(30) Foreign Application Priority Data
May 19, 2023 (KR) 10-2023-0064892

(51) Int. Cl. A01N 43/16; A01N 25/02; A01N 59/16; A01P 1/00

(52) U.S. Cl. CPC A01N 43/16; A01N 25/02; A01N 59/16; A01P 1/00

(57) ABSTRACT

Proposed is a one-component antibacterial and antiviral coating composition capable of killing various pathogenic microorganisms or preventing infection caused thereby. The coating composition can be sprayed onto a substrate, regardless of the physical properties of the substrate, to achieve a microbicidal effect that inactivates various pathogenic microorganisms. In addition, a coating method disclosed herein is excellent in terms of convenience and economic feasibility, and thus can be widely applied to disinfection and disease-preventive methods for various facilities such as greenhouses, livestock barns, and poultry farms, as well as household goods.

### CROSS-REFERENCE TO RELATED APPLICATIONS

This application is a continuation of International Patent Application No. PCT/KR2023/018059 filed on Nov. 10, 2023, which claims priority to, and the benefit of Korean Patent Application No. 10-2023-0064892 filed in the Korean Intellectual Property Office on May 19, 2023, the entire contents of which are incorporated herein by reference.

### 1. FIELD

The present disclosure relates to an antibacterial and antiviral coating composition containing a supramolecular sol including a polyphenol-based compound and a trivalent iron salt, a coating method using the same, and a coating film.

### 2. DESCRIPTION OF THE RELATED ART

Disinfection effective against viruses is crucial for preventing the transmission of infectious diseases between humans or between animals and humans. However, developing disinfectants capable of inactivating a variety of viruses is challenging. Fungi and bacteria can also be susceptible to transmission through various household goods and facilities, and epidemics resulting from such transmission may cause serious problems, particularly in the livestock, food, and other related industries. Considering the diversity of such pathogenic species, it is required to develop a novel type of disinfectant that can be safely used for human health and the environment, stored for long term, and effective over a broad spectrum.

Polyphenol-metal compounds prepared by bonding polyvalent metal ions and polyphenols such as tannic acid through coordination bonding are advantageously applied to various fields, including chemistry, biomedicine, engineering, and materials science. Tannic acid and iron salts have been approved by the U.S. Food and Drug Administration (FDA) as cosmetic ingredients and food additives. Tannic acid, a naturally occurring compound found in plants, is a secondary metabolite that protects plants against pathogens and ultraviolet radiation, while iron is closely related to antimicrobial activity. Considering safety, economic efficiency, and microbicidal effects, tannic acid and iron salts show natural antimicrobial and virucidal effects against a wide range of pathogenic species, so research on these substances has been conducted several times.

To date, most antimicrobial coating methods involving polyphenol-metal compounds have utilized a dip-coating method based on immersion of a substrate. However, the dip-coating process inevitably has difficulties in coating bulk or rigid (fixed) substrates, and therefore has limitations for use in general disinfectants. To overcome such limitations, the inventors of the present disclosure have developed a spray coating method. However, polyphenol-based compounds and trivalent iron salts are rapidly precipitated when mixed in an aqueous solution, so two physically separated coating compositions in respective ports had to be used. Accordingly, considering the use as a disinfectant, there is a need to develop coating compositions and coating methods that provide greater convenience and persistence than existing spray coating methods.

### SUMMARY

One objective of the present disclosure is to provide a one-component antibacterial and antiviral coating composition capable of killing or preventing various pathogenic microorganisms.

Another objective of the present disclosure is to provide a coating method using the coating composition capable of killing various pathogenic microorganisms or preventing infection caused thereby.

An antibacterial and antiviral coating composition effective against microorganisms and viruses, according to the present disclosure, may contain: a supramolecular sol including a polyphenol-based compound and a trivalent iron salt; and water, wherein the trivalent iron salt is included in an amount of 2 moles or more with respect to 1 mole of the polyphenol-based compound, and the polyphenol-based compound is included at a concentration in a range of 2 to 50 mM.

The trivalent iron salt may be included at a concentration in a range of 20 to 200 mM.

The polyphenol-based compound may be tannic acid.

The trivalent iron salt may include a combination of one or more selected from the group consisting of ferric sulfate, ferric chloride, ferric nitrate, and hydrates thereof.

The microorganisms may include a combination of one or more selected from the group consisting of Escherichia coli, Salmonella typhimurium, Staphylococcus aureus, Acinetobacter baumannii, Pleurotus ostreatus, and Trichophyton rubrum.

The viruses may include a combination of one or more selected from the group consisting of influenza A virus, severe acute respiratory syndrome coronavirus 2 (SARS-CoV-2), and human rhinovirus.

The composition may be a one-component composition and may be sprayed through a single nozzle to form a coating film on a substrate.

An antibacterial and antiviral coating film of the present disclosure may be prepared from the antibacterial and antiviral coating composition according to one embodiment of the present disclosure.

The coating film may be formed by curing the coating composition sprayed in the air on a substrate.

A coating method, according to the present disclosure, may include the following steps: preparing a coating composition by mixing a polyphenol-based compound, a trivalent iron salt, and water, spraying the coating composition onto a substrate; and forming a coating film on the substrate.

The spraying step may be to spray the coating composition through a single nozzle.

The film may have an average thickness in a range of 3 to 100 nm.

A bactericidal and virucidal method of the present disclosure may involve spraying an antibacterial and antiviral coating composition, according to one embodiment of the present disclosure, onto contaminated surfaces and areas.

A disinfection and disease-preventive method for a facility of the present disclosure may be characterized by including the following steps: individually spraying an antibacterial and antiviral coating composition, according to one embodiment of the present disclosure, onto a surface of a facility requiring disinfection; and forming a coating film on the surface of the facility, wherein the facility includes one or more selected from the group consisting of a greenhouse, a pig barn, a cattle barn, a poultry farm, and a fish farm, and the coating composition imparts antibacterial and antiviral properties to the surface of the facility.

An antibacterial and antiviral coating composition, according to the present disclosure, can be sprayed onto a substrate, regardless of the physical properties of the substrate, to achieve a microbicidal effect that inactivates various pathogenic microorganisms.

In addition, a coating method, according to the present disclosure, is excellent in terms of convenience and economic feasibility, and thus can be widely applied to disinfection and disease-preventive methods for various facilities such as greenhouses, livestock barns, and poultry farms, as well as household goods.

### BRIEF DESCRIPTION OF THE DRAWINGS

FIGS. 1, 2A and 2B show coating film thickness measured with an ellipsometer as a function of component ratio in a coating composition.

FIG. 3 shows the viral titers of influenza A virus subtypes following treatment with a tannic acid (TA)-Fe³⁺-metal-phenolic supramolecular sol (MPS) coating composition, quantified by immunofluorescence.

FIG. 4 shows the viral titers of SARS-COV-2 following treatment with a TA-Fe³⁺-MPS coating composition, quantified by immunofluorescence.

FIG. 5 shows the viral titers of human rhinovirus (HRV)-14 following treatment with a TA-Fe³⁺-MPS coating composition, quantified by immunofluorescence.

FIG. 6 shows the virucidal effect of a TA-Fe³⁺-MPS coating composition as a function of treatment time, quantified by immunofluorescence.

FIG. 7 shows the virucidal effect of a TA-Fe³⁺-MPS coating composition as a function of temperature, quantified by immunofluorescence.

FIG. 8 shows the appearance of E. coli media following treatment with a TA-Fe³⁺-MPS coating composition, and the corresponding colony-forming unit (CFU) counts.

FIG. 9 shows the appearance of S. typhimurium media following treatment with a TA-Fe³⁺-MPS coating composition, and the corresponding CFU counts.

FIGS. 10A and 10B show the CFU counts of S. aureus and A. baumannii in experimental and control groups.

FIG. 11 shows the appearance of P. ostreatus from Day 1 to 7 following treatment with a TA-Fe³⁺-MPS coating composition.

FIG. 12 shows the appearance of T. rubrum following treatment with a TA-Fe³⁺-MPS coating composition, presenting (left) a control group in which water is sprayed and (right) an experimental group in which the TA-Fe³⁺-MPS coating composition is sprayed.

FIG. 13 shows the contact angles of water droplets on various substrates before and after spraying a TA-Fe³⁺-MPS coating composition (AC: poly(acrylic acid), Al:

aluminum, Au: gold, Cu: copper, PS: polystyrene, PTFE: polytetrafluoroethylene, Si: silicon, Sn: tin, SS: stainless steel, Ti: titanium).

FIG. 14 shows (left) a bare gold substrate and (middle) a TA-Fe³⁺-MPS-coated substrate measured with a field emission scanning electron microscope (FE-SEM), and (right) an image of a TA-Fe³⁺-MPS coating film measured with an atomic force microscope (AFM) (scale bar: 1 μm).

FIGS. 15A and 15B show the narrow scan X-ray photoelectron spectroscopy (XPS) spectra of (A) Fe³⁺ and (B) TA measured by XPS.

FIG. 16 shows the ultraviolet-visible (UV-vis) absorbance spectrum of a TA-Fe³⁺-MPS coating film, determined by UV-vis spectroscopy.

FIG. 17 shows the appearance of a cotton fabric before and after spraying a TA-Fe³⁺-MPS coating composition.

FIG. 18 shows changes in L* value as a function of the number of washing-drying cycles of a cotton fabric on which a TA-Fe³⁺-MPS coating film is formed.

FIG. 19 shows the virucidal and bactericidal effects of spraying a TA-Fe³⁺-MPS coating composition on microorganisms collected from (a) an air filter membrane, (b) a toilet seat, (c) a kitchen sink, (d) a refrigerator, (e) a disposable face mask, and (f) a mobile phone, presenting (left) control groups in which no spraying is performed and (right) experimental groups in which a TA-Fe³⁺-MPS coating composition is sprayed.

FIG. 20A shows the appearance of media inoculated respectively with experimental groups collected from a toilet seat, a kitchen sink, and a mobile phone onto which a TA-Fe³⁺-MPS coating composition is directly sprayed, and with control groups collected from a toilet seat, a kitchen sink, and a mobile phone in which no spraying is performed.

FIG. 20B shows the colony units per plate for the respective media of the experimental and control groups in FIG. 20A.

FIG. 21 shows the average surface area of TA-Fe³⁺-MPS particles as a function of time after preparing a TA-Fe³⁺-MPS coating composition, measured with a confocal laser scanning microscope (CLSM).

FIG. 22 shows the bactericidal activity of a TA-Fe³⁺-MPS coating composition against E. coli when eight weeks elapse after preparation.

### DETAILED DESCRIPTION

The present disclosure will be described in detail below. Unless otherwise defined, terms used in this specification are to be interpreted as generally understood by those skilled in the art. The drawings and embodiments in this specification are provided to enable those skilled in the art to readily understand and practice the present disclosure. Any elements that may obscure the gist of the present disclosure may be omitted from the drawings and embodiments, and the present disclosure is not limited to the drawings and embodiments.

Unless the context clearly indicates otherwise, the singular forms used in this specification are intended to include the plural forms.

Furthermore, a numerical range used in the present disclosure includes its upper and lower limits and all possible combinations of all values falling within such limits, increments logically derived from the form and width of the defined range, all defined values thereof, and upper and lower limits of the numerical range defined in different types. In this specification of the present disclosure, unless otherwise clearly defined, values outside the numerical range, which may result from the rounding off of the experimental errors or values, also fall within the defined numerical range.

It will be further understood that the terms “comprise”, “include”, “have”, and the like, when used in this specification, specify the presence of stated features or components herein, but do not preclude the possibility of the presence or addition of one or more other features or components.

Hereinafter, an antibacterial and antiviral coating composition, a coating method using the same, and a coating layer, according to the present disclosure, will be described in more detail.

The present disclosure provides an antibacterial and antiviral coating composition effective against microorganisms and viruses, the antibacterial and antiviral coating composition containing: a supramolecular sol (MPS) including a polyphenol-based compound and a trivalent iron salt; and water, wherein the trivalent iron salt is included in an amount of 2 moles or more with respect to 1 mole of the polyphenol-based compound, and the polyphenol-based compound is included at a concentration in the range of 2 to 50 mM.

Specifically, with respect to 1 mole of the polyphenol-based compound, the trivalent iron salt may be included in an amount in the range of 2 to 15 moles, more specifically in the range of 2 to 10 moles, and preferably in the range of 2 to 8 moles. In addition, the polyphenol-based compound may be included at a concentration in the range of 2 to 40 mM, preferably in the range of 2 to 30 mM. When the polyphenol-based compound is mixed while satisfying the above-described molar ratio and concentration, excellent antiviral and antibacterial effects can be achieved. In addition, the polyphenol-based compound and trivalent iron salt mixed are not readily precipitated and, therefore, can be used conveniently as a single-phase liquid coating composition, which is desirable.

The polyphenol-based compound and the trivalent iron salt form the supramolecular sol in an aqueous solution. Despite exhibiting a particulate nature, the supramolecular sol has sprayability and film formation ability. Accordingly, the coating composition can serve as a coating composition that is sprayed onto a substrate, thereby forming a coating film on the surface of the substrate and inactivating pathogenic microorganisms.

Supramolecular sols (MPS), which are formed by self-assembly of phenol-based ligands and metal ions through coordination bonding, may differ in physicochemical properties, including size, stiffness, and permeability, depending on the type and bonding ratio of polyphenols and metal ions. Additionally, the supramolecular sol forms a continuous metal-phenolic network on the surface of the substrate and forms a strong bonding force, thereby forming a coating layer with strong durability.

Polyphenol-based compounds and trivalent iron salts are known to readily form precipitates in aqueous solutions, which is problematic in that a spray formulation must employ multiple ports and nozzles to physically separate the respective components. However, the coating composition, according to the present disclosure, forms a stable supramolecular sol in an aqueous solution without readily precipitating, even when mixed in a single port. Accordingly, while existing as a stable aqueous solution before being sprayed onto the substrate, the supramolecular sol, after being sprayed, may form a continuous metal-phenolic network on the substrate, thereby forming a stable coating film.

More particularly, the antibacterial and antiviral coating composition, according to the present disclosure, overcomes the limitations of compositions for dip coating based on immersion of a substrate, used in existing coating methods. The antibacterial and antiviral coating composition does not form precipitates under the conditions of the molar ratio and concentration range as described above, even when mixed in a single port without physically separating the polyphenol-based compound and the trivalent iron salt. In addition, the antibacterial and antiviral coating composition maintains a stable liquid phase and can thus provide excellent convenience as a spray formulation. Furthermore, because there is no limitation on the substrates to be coated, the antibacterial and antiviral coating composition can be advantageously applied to the coating of bulk or rigid (fixed) substrates.

According to one embodiment of the present disclosure, the trivalent iron salt may be included at a concentration in the range of 20 to 200 mM, specifically in the range of 20 to 150 mM, and more specifically in the range of 20 to 100 mM.

The polyphenol-based compound may be TA.

TA or tannin is a natural polyphenol existing in various plants and tree roots, which is a substance with useful physiological activities, including antimicrobial activity, antioxidant activity, anti-tumor activity, and heavy metal removal ability. TA, or tannin, can be extracted in large quantities at low cost and thus provides high economic feasibility. The five pyrogallol groups and five catechol groups of TA provide numerous binding sites for various interactions, such as hydrogen bonding, ionic bonding, coordination bonding, and hydrophobic interactions, so TA is useful in forming metal-phenolic networks through coordination bonding with metal ions.

The trivalent iron salt, according to the present disclosure, may be an inorganic acid salt containing ferric ions, which may specifically include a combination of one or more selected from the group consisting of ferric sulfate, ferric chloride, ferric nitrate, and hydrates thereof. However, there are no limitations.

The antibacterial and antiviral coating composition, according to the present disclosure, is sprayed onto the substrate to form the coating film, and can kill pathogenic species existing on the substrate or prevent the proliferation or production of such pathogenic species. Specifically, the pathogenic species may include one or more selected from the group consisting of bacteria and fungi. Specifically, the pathogenic species may include a combination of one or more selected from the group consisting of Escherichia coli, Salmonella typhimurium, Staphylococcus aureus, Acinetobacter baumannii, Pleurotus ostreatus, and Trichophyton rubrum. However, there are no limitations.

The antibacterial and antiviral coating composition, according to the present disclosure, may also kill viruses. Specifically, the viruses may include a combination of one or more selected from the group consisting of influenza A virus, SARS-COV-2, and HRV. However, there are no limitations.

The antibacterial and antiviral coating composition, according to the present disclosure, is a one-component composition and may be sprayed through a single nozzle to form a coating film on the substrate. In order to form coating films including existing polyphenol-based compounds and trivalent iron salts, the inventors of the present disclosure have proposed a coating method by spraying the polyphenol-based compound and the trivalent iron salt through respective nozzles to overcome the inherent problem thereof, that is, precipitation. However, in the present disclosure, a one-component coating composition that can overcome the problem regarding precipitation, as described above, and is sprayable using a single nozzle is provided, thereby significantly improving user convenience.

The present disclosure provides an antibacterial and antiviral coating film formed from an antiviral coating composition according to one embodiment.

Specifically, the antibacterial and antiviral coating film, according to the present disclosure, may include a complex compound form in which trivalent iron ions are bonded to the hydroxyl group of the polyphenol-based compound through coordination bonding. The coating film formed in such a manner achieves antibacterial and antiviral effects.

The coating film may be formed by curing the antibacterial and antiviral coating composition sprayed in the air on a substrate. The distance between the substrate and a nozzle inlet through which the coating composition is sprayed may be in the range of 3 to 15 cm, specifically in the range of 3 to 10 cm, and more specifically, 5 cm. However, there are no limitations.

A coating method, according to one embodiment of the present disclosure, may include the following steps: preparing a coating composition by mixing a polyphenol-based compound, a trivalent iron salt, and water; spraying the coating composition onto a substrate; and forming a coating film on the substrate.

The spraying step may be to spray the coating composition through a single nozzle.

The film may have an average thickness in the range of 3 to 100 nm, specifically in the range of 5 to 50 nm and more specifically in the range of 5 to 30 nm. However, there are no limitations.

The step of spraying the coating composition onto the substrate may be performed by spraying the coating composition in a spray form and, in particular, may be performed by spraying the coating composition using a piston pump-type spray container known in the art, in which the coating composition is contained.

Furthermore, in another aspect for spraying the coating composition in a spray form onto the substrate, an aerosol container containing the coating composition with a propellant therein may be used. The propellant may be liquefied by internal pressure and contained in the container, thus facilitating spraying of the coating composition in a spray form. The liquefiable propellant may be selected from liquefied petroleum gases (LPGs), such as propane gas, butane gas, and a mixture gas of propane and butane, dimethyl ether (DME), and the like. However, there are no limitations. The amount of the propellant contained may be selected depending on the viscosity and spraying degree of the contents in the container. For example, the aqueous coating composition and the propellant, contained in the container, may be mixed in a weight ratio in the range of 1:9 to 9:1. However, there are no limitations.

The coating composition may be formulated in a spray form through the aerosol container, thereby providing excellent user convenience. In addition, due to the characteristics of the spray form, the contents can be stored in a sealed state from the outside, thereby significantly improving the storage stability of the coating composition.

Accordingly, the present disclosure provides a bactericidal and virucidal method.

The bactericidal and virucidal method of the present disclosure may involve spraying an antibacterial and antiviral coating composition onto contaminated surfaces and areas.

The contaminated surfaces and areas may be contaminated with one or more pathogenic species consisting of viruses, bacteria, fungi, and the like. However, there are no limitations.

Furthermore, the present disclosure provides a disinfection and disease-preventive method for a facility.

The disinfection and disease-preventive method for the facility of the present disclosure may be characterized by including the following steps: individually spraying an antibacterial and antiviral coating composition, according to one embodiment, onto a surface of a facility requiring disinfection; and forming a coating film on the surface of the facility, wherein the facility includes one or more selected from the group consisting of a greenhouse, a pig barn, a cattle barn, a poultry farm, and a fish farm, and the coating composition imparts antibacterial and antiviral properties to the surface of the facility.

In the disinfection and disease-preventive method for the facility of the present disclosure, the facility is not limited in types as long as it is a facility or space for breeding and protecting animals and plants.

Hereinafter, the antibacterial and antiviral coating composition and the coating method using the same, according to the present disclosure, will be described in more detail through specific examples. However, each of the following examples is only a reference for explaining the present disclosure in detail. The present disclosure is not limited thereto and may be implemented in various forms. Furthermore, the terms used in the description of the present disclosure are disclosed only for effectively describing particular examples and are not intended to limit the present disclosure.

### Examples 1 to 8 and Comparative Examples 1 to 4

At room temperature, 10 mL each of a TA aqueous solution and an Fe³⁺ aqueous solution were mixed at concentrations shown in Table 1 below and reacted for 30 minutes, thereby preparing TA-Fe³⁺-MPS coating compositions.

TABLE 1

| | Example | | | | | | | | Comparative Example | | | | |
|---|---|---|---|---|---|---|---|---|---|---|---|---|---|
| | 1 | 2 | 3 | 4 | 5 | 6 | 7 | 8 | 1 | 2 | 3 | 4 | 5 |
| TA | 6 | 12 | 3 | 6 | 12 | 24 | 3 | 6 | 6 | 6 | 24 | 1.5 | 1.5 |
| solution (mM) | | | | | | | | | | | | | |
| Fe³⁺ | 12 | 24 | 12 | 24 | 48 | 96 | 24 | 48 | 3 | 6 | 24 | 6 | 24 |
| Solution (mM) | | | | | | | | | | | | | |

| | | | | | | | |
|---|---|---|---|---|---|---|---|
| [TA]:[Fe³⁺] | 1:2 | 1:4 | 1:8 | 2:1 | 1:1 | 1:4 | 1:16 |

### [Experimental Example 1] Thickness of Coating Film Formed from Coating Compositions

At room temperature, the distance between a coating composition sprayer and a gold substrate was fixed at 5 cm, and the TA-Fe³⁺-MPS coating compositions prepared in the above examples and comparative examples were sprayed five times. Then, the substrates were washed with deionized water (pH 7.5, adjusted with a 1 M NaOH solution) to remove a TA-Fe³⁺ complex, and dried under an argon flow. The thickness of the coating films was measured with an ellipsometer.

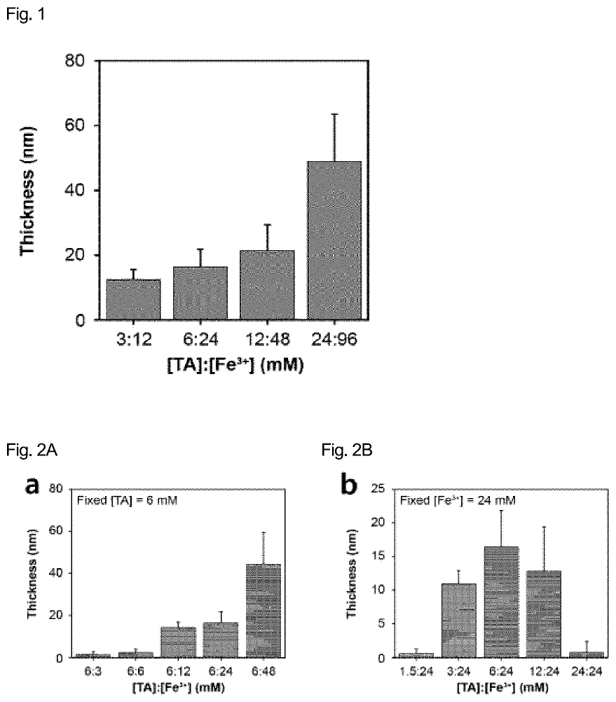

As shown in FIG. 1, when the molar concentration ratio of TA and Fe³⁺ in the coating composition is 1:4, the thickness of the coating films increases as the concentration of TA increases, confirming that all the coating compositions of Examples 3 to 6 appropriately form coating films. In addition, as shown in FIGS. 2A and 2B, at the molar concentration of TA in the coating composition fixed at 6 mM, or at the molar concentration of Fe³⁺ in the coating composition fixed at 24 mM, all the coating compositions, according to the corresponding examples, were confirmed to stably form the coating films having a thickness of 10 nm or larger. On the other hand, in the case of the coating compositions of Comparative Examples 1 to 4, the thickness of the coating films was 1 nm or smaller, confirming that the coating films were inappropriately formed. In other words, in one aspect, it is found that a coating film of excellent thickness can be formed when Fe³⁺ is included in an amount of 2 moles or more with respect to 1 mole of TA, and the molar concentration of TA is 2 mM or higher.

### [Experimental Example 2] Virucidal Effect of Coating Composition

### <Enveloped Virus>

Influenza A virus strains A/Puerto Rico/8/1934 (PR8; H1N1) and A/Hong Kong/8/1968 (HK; H3N2) were used in this experiment. PR8 (2×10⁶ PFU/mL) was added in the same amount as the TA-Fe³⁺-MPS coating composition prepared in Example 4 or a control group serum-free minimal essential medium (MEM) and then incubated at room temperature for 30 minutes. The incubated virus suspension was subjected to 10-fold serial dilution in MEM containing tosyl phenylalanyl chloromethyl ketone (TPCK)-treated trypsin. Thereafter, Madin-Darby canine kidney (MDCK) cells were treated with 100 μL of the diluted sample, followed by inoculation into a 96-well microplate. As the control group, a virus suspension free of the TA-Fe³⁺-MPS coating composition was subjected to dilution, followed by treating MDCK cells with the diluted sample. Each cell was incubated at 33° C., fixed on the third day, and stained with crystal violet for 1 hour. The number of stained wells among a total of eight wells was counted to determine the cell survival percentage.

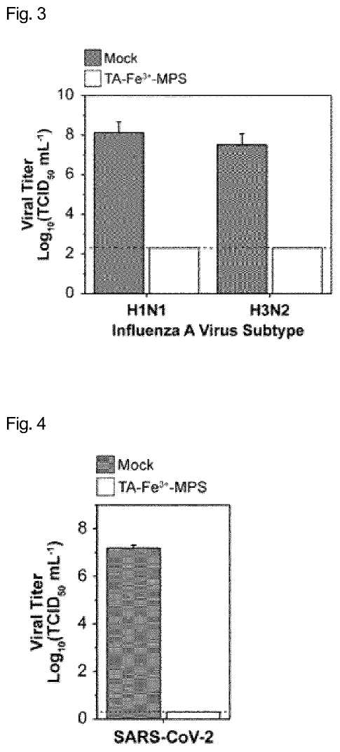

As quantitatively shown in FIG. 3, influenza A virus incubated for 30 minutes in the presence of the TA-Fe³⁺-MPS coating composition showed a loss of viral infectivity, with the viral titer decreasing below the limit of detection (LOD). On the other hand, in the case of the control group, it is found that the titers of the PR8 influenza virus and the HK influenza virus are 8.1±0.5 log(TCID₅₀/mL) and 7.5±0.6 log(TCID₅₀/mL), respectively.

Whether the virucidal effect of the TA-Fe³⁺-MPS coating composition was reproducible against SARS-COV-2 was further investigated. SARS-COV-2 (hCoV-19/Korea/KCDC06/2020) was obtained from the Korea Centers for Disease Control and Prevention for use. For the investigation of viral infectivity in Vero cells, the same dose of the TA-Fe³⁺-MPS coating composition and strain as used in the analysis of influenza A virus was employed, thereby preparing an experimental group and a control group in the presence or absence of the TA-Fe³⁺-MPS coating composition, respectively. The analysis was conducted using immunofluorescence staining of viral spikes. According to FIG. 4, it was observed that the titer (7.2±0.1 log(TCID₅₀/mL)) of SARS-COV-2 rapidly decreased to LOD or below in the presence of the TA-Fe³⁺-MPS. Accordingly, it was found that the TA-Fe³⁺-MPS coating film significantly reduced the infectivity of influenza A virus and SARS-COV-2.

### <Non-Enveloped Virus>

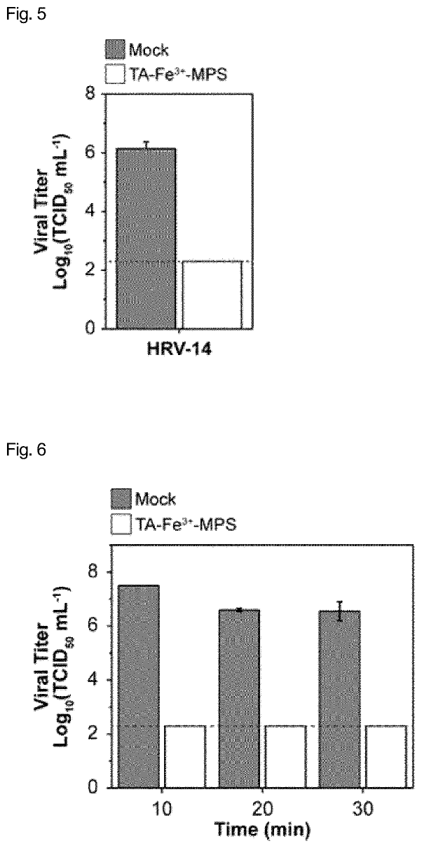

Considering the difficulties in removing non-enveloped viruses compared to removing enveloped viruses, whether the TA-Fe³⁺-MPS coating composition also had a virucidal effect against HRV-14, a non-enveloped virus, was investigated. H1 Hela cells were treated with an HRV-14 suspension containing the TA-Fe³⁺-MPS coating composition in accordance with the same procedure used in the analysis of influenza A virus. Then, an HRV-14 suspension free of the TA-Fe³⁺-MPS coating composition was used as a control group, followed by measuring the TCID₅₀ values of the two samples. According to FIG. 5, the TA-Fe³⁺-MPS was observed to eliminate the infectivity of HRV-14.

To summarize the above results, it is confirmed that the TA-Fe³⁺-MPS coating film can inactivate both enveloped and non-enveloped viruses, and is a broad-spectrum virucide available for immediate use.

### [Experimental Example 3] Testing of Virucidal Rate and Temperature Conditions of Coating Composition

### <Testing of Virucidal Rate>

Using the PR8 influenza virus, how rapidly the TA-Fe³⁺-MPS coating composition showed a virucidal effect was investigated. The PR8 influenza virus was incubated with the TA-Fe³⁺-MPS coating composition prepared in Example 4 at room temperature for 10, 20, or 30 minutes. As shown in FIG. 6, the viral titer was found to have already decreased to the baseline level within 10 minutes. Accordingly, the TA-Fe³⁺-MPS coating film was demonstrated to inactivate the virus with a titer of about 7.5 log(TCID₅₀/mL) within 10 minutes.

### <Testing of Temperature>

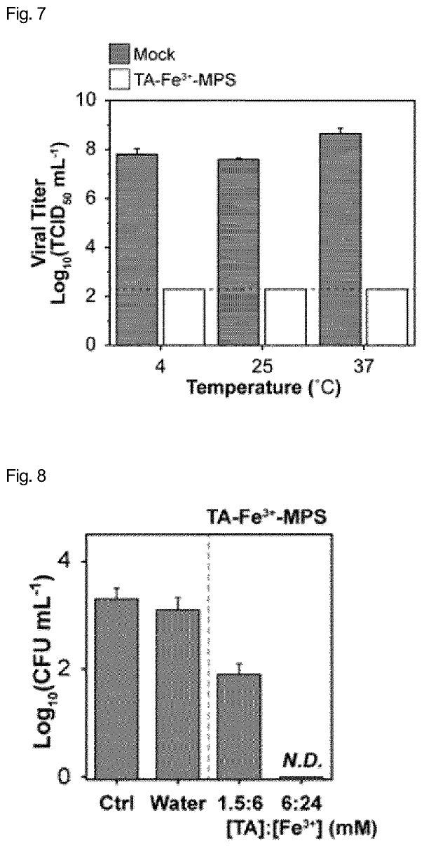

To evaluate the temperature dependence of the virucidal effect of the TA-Fe³⁺-MPS coating film, 20 mL of PR8 (2×10⁶ PFU/mL) was added to the TA-Fe³⁺-MPS coating composition prepared in Example 4, followed by incubation for 30 minutes at each of the different temperatures of 4° C., 25° C., and 37° C. According to FIG. 7, when adding the TA-Fe³⁺-MPS coating composition at varying temperatures, it is found that the viral titer decreases similarly, and the TA-Fe³⁺-MPS coating composition is usable in climates with temperatures between 4° C. and 37° C., covering both cold and hot conditions. In summary, this clearly suggests that the virucidal effect of the TA-Fe³⁺-MPS coating film can lead to inactivation of the virus within 10 minutes, regardless of the range of varying temperatures.

### [Experimental Example 4] Microbicidal Effect of Coating Composition

### <Pathogenic Bacteria>

E. coli and S. typhimurium were selected as model pathogenic bacteria for testing the bactericidal ability of the TA-Fe³⁺-MPS coating film. To confirm the bactericidal effect of the TA-Fe³⁺-MPS, E. coli was incubated on Luria-Bertani (LB) agar medium, and then the TA-Fe³⁺-MPS coating compositions of Example 3, Example 4, and Comparative Example 4, in which the [TA]: [Fe³⁺] ratios were 3:12, 6:24, and 1.5:6 (mM), respectively, were each independently sprayed onto different media. In addition, water was sprayed after incubating E. coli on the LB agar medium, and a medium onto which no substance was sprayed was prepared as a control group (Ctrl). The medium onto which each substance was sprayed was incubated for 24 hours, followed by measuring the CFU.

As shown in FIG. 8, the CFU in the medium in which no spraying was performed was calculated as 3.3±0.2 log(CFU/mL), while the CFU in the medium onto which only water was sprayed was calculated as 3.1±0.2 log(CFU/mL). In the meantime, it is confirmed that the coating composition of Example 4 exhibits a significantly lower CFU value than the coating composition of Comparative Example 4, and that colonies are hardly observed in the media using the coating compositions of the examples.

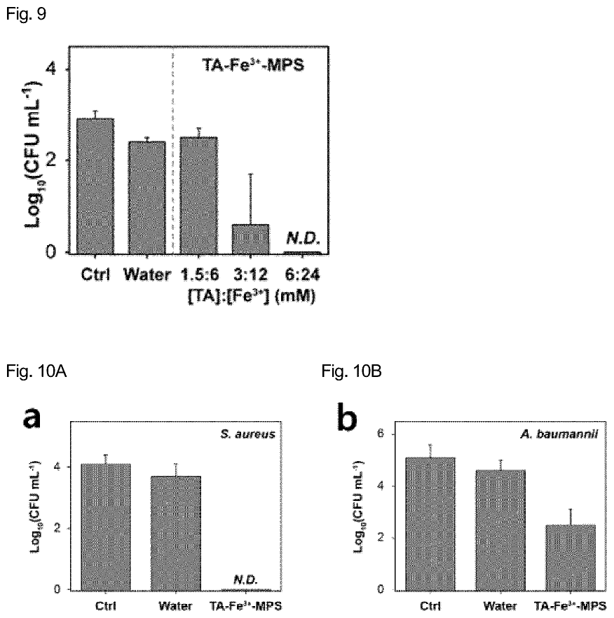

The testing of the bactericidal ability against S. typhimurium was also performed in the same manner as above. According to FIG. 9, in xylose-lysine-deoxycholate (XLD) agar media on which S. typhimurium had been incubated and onto which the TA-Fe³⁺-MPS coating compositions of Examples 4 and 5, in which the [TA]: [Fe³⁺] ratios were 3:12 and 6:24, respectively, were then sprayed, no growth of S. typhimurium was observed at all after 24 hours of incubation. On the other hand, the CFUs in an medium in which no spraying was performed and a medium onto which only water was sprayed were calculated as 2.9±0.2 log(CFU/mL) and 2.4±0.1 log(CFU/mL), respectively, demonstrating that E. coli and S. typhimurium were killed by the formation of the TA-Fe³⁺-MPS coating films, depending on the amount of the composition contained in each example.

The testing of the bactericidal ability of the TA-Fe³⁺-MPS coating film against multiple drug-resistant pathogens, S. aureus and A. baumannii, was also performed in the same manner as above. According to FIG. 10A, in tryptic soy agar (TSA) medium on which S. aureus had been incubated and onto which the TA-Fe³⁺-MPS coating composition was sprayed, no growth of S. aureus was observed at all after 24 hours of incubation. On the other hand, the CFUs in a medium in which no spraying was performed and a medium onto which only water was sprayed were calculated as 4.1±0.3 log(CFU/mL) and 3.7±0.4 log(CFU/mL), respectively. In FIG. 10B, as a result of calculating the CFUs after incubating A. baumannii in TSA medium, it was found that the CFUs in a medium in which no spraying was performed and a medium onto which only water was sprayed were calculated as 5.1±0.5 log(CFU/mL) and 4.6±0.4 log(CFU/mL), respectively, while the CFU in a medium incubated after spraying the TA-Fe^{3±}-MPS coating composition significantly decreased to 2.5±0.6 log(CFU/mL).

### <Fungi>

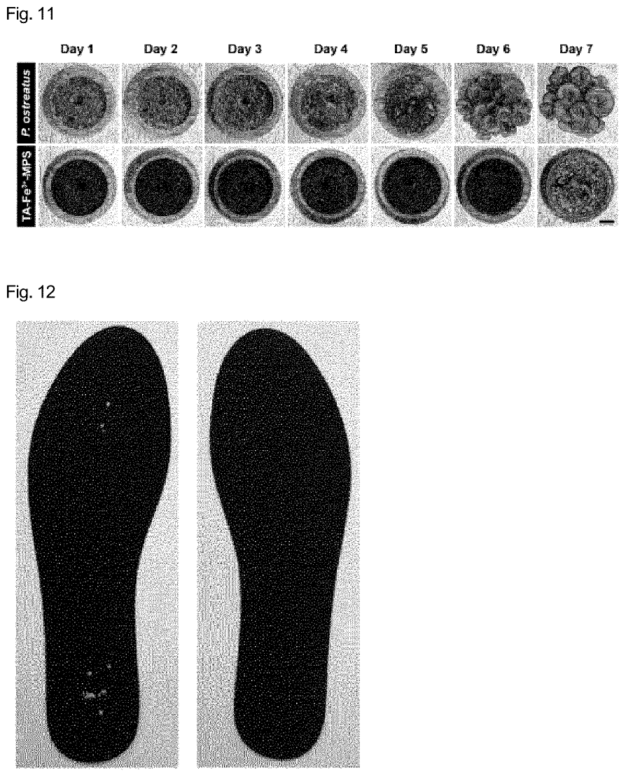

In addition to pathogenic bacteria, some fungi also cause diseases. For this reason, the fungicidal ability of the TA-Fe³⁺-MPS coating composition against fungi was investigated using P. ostreatus as a model. The TA-Fe³⁺-MPS coating composition of Example 4 was sprayed onto P. ostreatus incubated in a mushroom cultivation bottle at room temperature once a day, followed by investigating mushroom growth for one week. A sample onto which water was sprayed under the same conditions as above was used as a control group. As shown in FIG. 11, in the control group, young mushrooms at the button stage were observed after 3 days of cultivation. Thereafter, the mushrooms continued to grow rapidly and became mature P. ostreatus with brown lamellae after 7 days. On the other hand, in the experimental group in which the TA-Fe³⁺-MPS coating composition was sprayed, the mushrooms remained at the button stage without further growth, and the stipe and cap appeared to shrink, indicating that the TA-Fe³⁺-MPS coating film inhibited mushroom growth and caused structural deformation.

The fungicidal effect of the TA-Fe³⁺-MPS coating composition was further investigated using T. rubrum, which causes skin infection known as athlete's foot, as a model. After immersing a commercial shoe insole in Sabouraud dextrose (SD) solution for 30 minutes to provide nutrients for colonization of T. rubrum, the insole was inoculated with T. rubrum and incubated at room temperature for 30 minutes. Thereafter, the TA-Fe³⁺-MPS coating composition of Example 4 was sprayed onto the insole once a day. Furthermore, a sample prepared by spraying water onto an insole under the same conditions as above was used as a control group. As shown in FIG. 12, white mold was observed after 2 days of incubation in the control group, while the growth and spread of T. rubrum were inhibited in the experimental group in which the coating film was formed by spraying the TA-Fe³⁺-MPS.

### [Experimental Example 5] Substrate Independence of Coating Composition (1)

### <Substrate Independence>

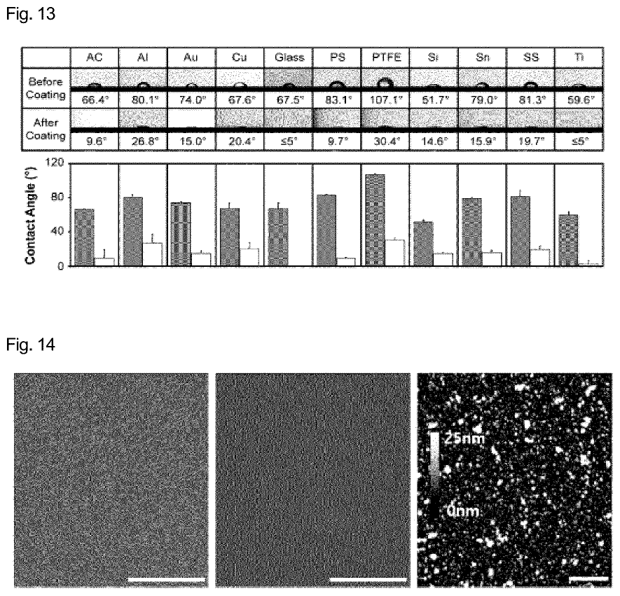

To investigate whether the TA-Fe³⁺-MPS spray system can be universally applied, the TA-Fe³⁺-MPS coating composition, prepared according to Example 4, was sprayed onto the surfaces of various substrates. Using AC, Al, Au, Cu, glass, PS, PTFE, Si, Sn, SS, and Ti as the substrates, the contact angles before and after spraying the TA-Fe³⁺-MPS coating composition were measured. As shown in FIG. 13, it was confirmed that all substrates became hydrophilic with contact angles of less than 30.4° after spraying the TA-Fe³⁺-MPS coating composition. Accordingly, it was found that TA-Fe³⁺-MPS coating layers were successfully formed on all substrates.

### <Confirmation of Coating Film Formation>

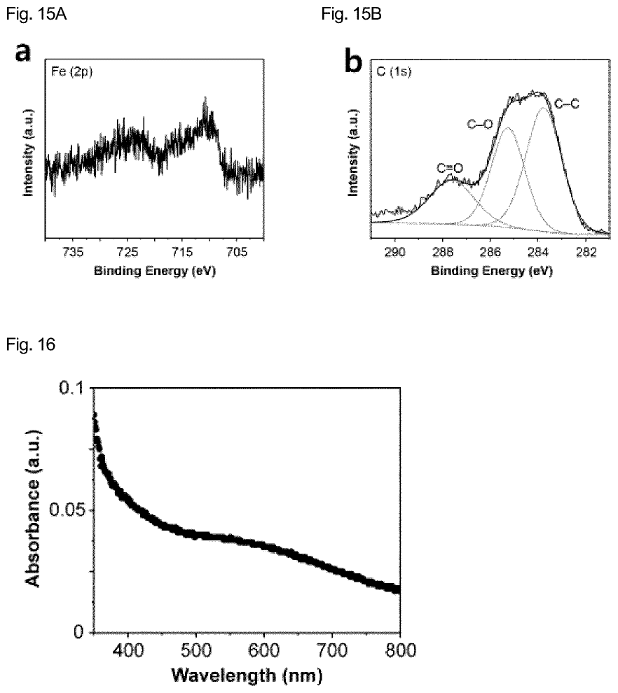

To confirm the formation of the TA-Fe³⁺-MPS coating film on a gold substrate, the TA-Fe³⁺-MPS-coated gold substrate in the above experiment was investigated using an FE-SEM, an AFM, XPS, and UV-vis spectroscopy. According to FIG. 14, it is found that a flat and uniform TA-Fe³⁺-MPS coating film is formed by spraying the TA-Fe³⁺-MPS coating composition. According to FIGS. 15A and 15B, the peaks at 711 and 724 eV in the spectrum graph on the left indicate the presence of Fe³⁺, and the peaks at 283, 285, and 287 eV in the spectrum graph on the right indicate the presence of TA. Furthermore, in the spectrum graph of FIG. 16, the broad peak between 500 and 600 nm appears to represent the ligand-to-metal charge transfer (LMCT) band of the TA-Fe³⁺ complex.

### [Experimental Example 6] Durability of Coating Film

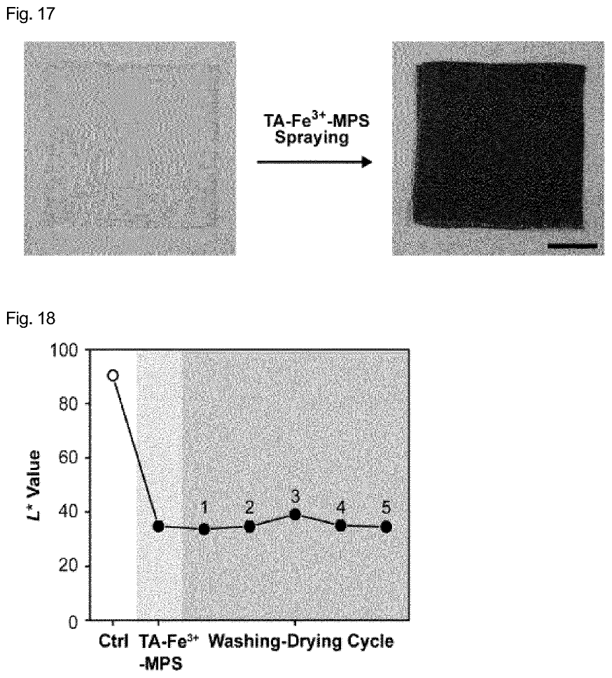

The TA-Fe³⁺-MPS coating composition prepared according to Example 4 was sprayed onto a cotton fabric five times, followed by washing the cotton fabric with deionized water (pH 7.5, adjusted with a 1 M NaOH solution) and drying at room temperature. The cotton fabric was washed with tap water and dried for durability analysis, followed by measuring the L* value in the CIELAB color space. L* was defined as 0 for black and 100 for white, and the L* value of the cotton fabric was measured before and after spraying the TA-Fe³⁺-MPS coating composition. According to FIG. 17, the white fabric turned dark purple immediately after spraying the TA-Fe³⁺-MPS coating composition. Furthermore, according to FIG. 18, it was found that the L* value after spraying the TA-Fe³⁺-MPS coating composition decreased rapidly from 90.4±0.4 to 34.7±1.6, showing that the TA-Fe³⁺-MPS coating layer was densely formed on the surface of the fabric. Thereafter, five washing-drying cycles were performed. During these cycles, no noticeable change in the L* value was observed, clearly demonstrating the durability of the coating.

### [Experimental Example 7] Substrate Independence of Coating Composition (2)

To confirm whether the TA-Fe³⁺-MPS spray system can be readily applied to various household goods, the microbicidal effects on an air filter membrane, a toilet seat, a kitchen sink, a refrigerator, a disposable face mask, and a mobile phone were investigated.

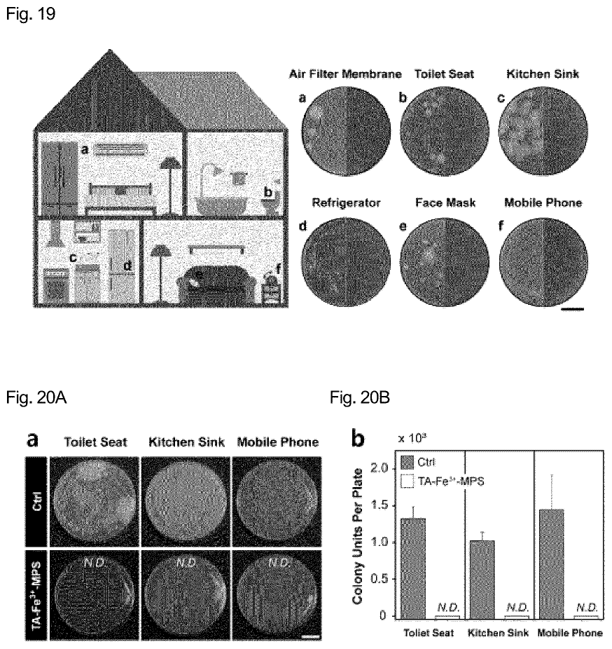

In a first experiment, samples were collected from each of the household goods and immersed in a 0.85% NaCl solution for 10 minutes, followed by applying 10-fold dilutions on plate count agar (PCA) medium. Then, after 30 minutes of incubation at room temperature, the TA-Fe³⁺-MPS coating composition was sprayed onto the PCA medium. According to FIG. 19, although various types of microorganisms were observed in all samples before spraying the TA-Fe³⁺-MPS coating composition, no colonies were observed in all samples after spraying the TA-Fe³⁺-MPS coating composition.

In a second experiment, the TA-Fe³⁺-MPS coating composition was sprayed directly onto a toilet seat, a kitchen sink, and a mobile phone. Then, samples were collected from the surface of each household good and incubated for 30 hours. As shown in FIG. 20A, in the case of all three items onto which the TA-Fe³⁺-MPS coating composition was sprayed, no colonies were detected on PCA media. Furthermore, according to FIG. 20B, in which the numbers of colonies were quantitatively measured, it was quantitatively confirmed that microorganisms were effectively inactivated. These results show that spraying the one-component TA-Fe³⁺-MPS coating composition effectively kills various microorganisms to which humans may be exposed in daily life.

### [Experimental Example 8] Long-Term Stability of Coating Composition

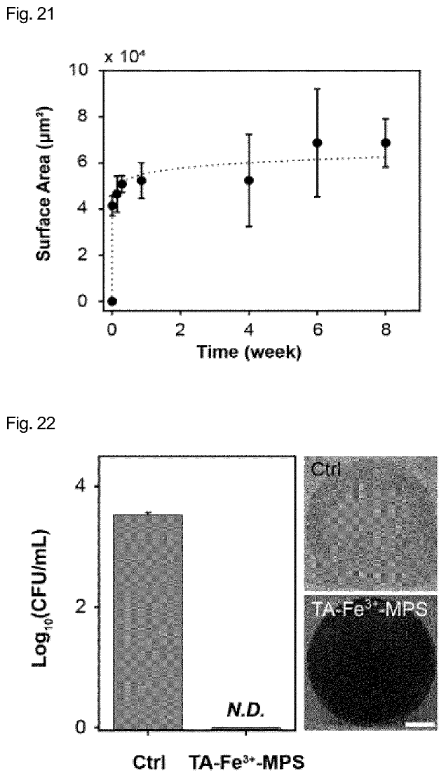

Degradation of the coating composition and formation of aggregates reduce the microbicidal effect and storage stability. For this reason, the long-term storage stability of the coating composition was investigated. TA-Fe³⁺-MPS particles in the coating composition of Example 4 were monitored for eight weeks using a CLSM in differential interference contrast (DIC) mode. The average surface area of the TA-Fe³⁺-MPS particles (that is, 640.17×640.17 μm²) was measured on the basis of DIC images. According to FIG. 21, data on the average surface area of the TA-Fe³⁺-MPS particles showed a logarithmic growth curve and, within just 3 hours after preparation, the TA-Fe³⁺-MPS particles rapidly increased from 0 to 0.04 mm², after which the rate of size increase slowed down. According to FIG. 22, the coating composition, even after eight weeks, completely inactivated the growth of E. coli in LB agar medium, thereby demonstrating the outstanding long-term stability of the TA-Fe³⁺-MPS spray system.

### [Experimental Example 9] Disinfection and Disease-Preventive Effect on Facility

To evaluate the disinfection and disease-preventive effects of spraying the TA-Fe³⁺-MPS coating composition on facilities, the TA-Fe³⁺-MPS coating composition prepared in Example 4 was sprayed in poultry facilities. Then, the number of flock deaths in a group in which no spraying was performed and a group in which spraying was performed, depending on flock age, was investigated. The results thereof are shown in Table 2 below.

TABLE 2

| | | No disinfection of | Disinfection |
|---|---|---|---|
| | | poultry house | of poultry |
| | | performed | house performed |
| Week | Flock age | Number of deaths | Number of deaths |
| 1 | 18 | 26 | 9 |
| 2 | 19 | 12 | 5 |
| 3 | 20 | 6 | 0 |
| 4 | 21 | 4 | 3 |
| Total | Number of deaths in | 48 | 17 |
| | Week 4 (mortality rate | | |
| | decreased by 65%) | | |
| 5 | 22 | 11 | 1 |
| 6 | 23 | 9 | 4 |
| 7 | 24 | 16 | 2 |
| 8 | 25 | 17 | 6 |
| Total | Number of deaths in | 101 | 30 |
| | Week 8 (mortality rate | | |
| | decreased by 70%) | | |
| 9 | 26 | 19 | 9 |
| 10 | 27 | 23 | 7 |
| 11 | 28 | 20 | 8 |
| 12 | 29 | 21 | 7 |
| Total | Number of deaths in | 184 | 61 |
| | Week 12 (mortality rate | | |
| | decreased by 67%) | | |
| 13 | 30 | 21 | 12 |
| 14 | 31 | 29 | 10 |
| 15 | 32 | 23 | 16 |
| 16 | 33 | 26 | 15 |
| Total | Number of deaths in | 283 | 114 |
| | Week 16 (mortality rate | | |
| | decreased by 60%) | | |
| 17 | 34 | 24 | 11 |
| 18 | 35 | 23 | 14 |
| 19 | 36 | 27 | 11 |
| 20 | 37 | 22 | 12 |
| Total | Number of deaths in | 379 | 162 |
| | Week 20 (mortality rate | | |
| | decreased by 57%) | | |
| 20 | 38 | 25 | 11 |
| 21 | 39 | 21 | 11 |

| | | |
|---|---|---|
| Total number of deaths (mortality | 425 | 184 |
| rate decreased by 57%) | | |

As shown in Table 2, when disinfecting poultry facilities with the TA-Fe³⁺-MPS coating composition of the present disclosure, it was found that the mortality rate of the flock decreased by 60% to 75% compared to that in the group in which no disinfection was performed. On this basis, it is confirmed that the TA-Fe³⁺-MPS coating composition of the present disclosure imparts antibacterial and antiviral properties to the surface of the facilities. Furthermore, this demonstrates that the coating composition, according to the present disclosure, is excellent in terms of convenience and economic feasibility, and thus can be widely applied to disinfection and disease-preventive methods for various facilities such as greenhouses, livestock barns, and poultry farms.

What is claimed is:

1. An antibacterial and antiviral coating composition effective against microorganisms and viruses, the coating composition comprising:
a supramolecular sol comprising a polyphenol-based compound and a trivalent iron salt; and
water,
wherein the trivalent iron salt is included in an amount of 2 moles or more with respect to 1 mole of the polyphenol-based compound, and
the polyphenol-based compound is included at a concentration in a range of 2 to 50 mM.

2. The coating composition of claim 1, wherein the trivalent iron salt is included at a concentration in a range of 20 to 200 mM.

3. The coating composition of claim 1, wherein the polyphenol-based compound is tannic acid.

4. The coating composition of claim 1, wherein the trivalent iron salt comprises a combination of one or more selected from the group consisting of ferric sulfate, ferric chloride, ferric nitrate, and hydrates thereof.

5. The coating composition of claim 1, wherein the microorganisms comprise a combination of one or more selected from the group consisting of Escherichia coli, Salmonella typhimurium, Staphylococcus aureus, Acinetobacter baumannii, Pleurotus ostreatus, and Trichophyton rubrum.

6. The coating composition of claim 1, wherein the viruses comprise a combination of one or more selected from the group consisting of influenza A virus, severe acute respiratory syndrome coronavirus 2 (SARS-COV-2), and human rhinovirus.

7. The coating composition of claim 1, wherein the composition is a one-component composition and is sprayed through a single nozzle to form a coating film on a substrate.

8. An antibacterial and antiviral coating film formed from the coating composition of claim 1.

9. The coating film of claim 8, wherein the coating film is formed by curing the coating composition sprayed in air on a substrate.
